(19) United States
(12) Patent Application Publication
(10) Pub. No.: US 2022/0351294 A1
(43) Pub. Date: Nov. 3, 2022

(54) DIGITAL INDICATORS FOR VIRTUAL SAVINGS BOND TRANSACTIONS

(71) Applicant: Wells Fargo Bank, N.A., San Francisco, CA (US)

(72) Inventor: David Joseph Brodsky, San Francisco, CA (US)

(21) Appl. No.: 16/703,295

(22) Filed: Dec. 4, 2019

(51) Int. Cl. G06Q 40/06; G06Q 40/02

(52) U.S. Cl. CPC G06Q 40/06; G06Q 40/02

(57) ABSTRACT

Techniques for remotely cashing savings bonds are disclosed herein. In an example, a transaction request for a debt security is received. Image data is received from a remote device that includes one or more digital images of the debt security. Valuation information is received from a valuation entity for the debt security that specifies a current monetary value of the debt security. A digital indicator is associated with the image data and includes the valuation information received from the valuation entity. Following association of the digital indicator with the image data, the transaction for the debt security is completed.

### TECHNICAL FIELD

This document pertains generally, but not by way of limitation, to savings bond transactions, and particularly but not by way of limitation to digital indicators for remote deposit capture of savings bonds.

### BACKGROUND

Government savings bonds are debt securities issued by a government entity. In the United. States, consumers have limited options to cash or deposit savings bonds that include visiting a local branch, or converting a physical bond to electronic forms using an online government service. When visiting a local branch, bank customers must deal with a time consuming process, and when converting to electronic forms using the online government service, the conversion process requires notarization of forms and the creation of a separate online account.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a network diagram illustrating a system that includes a remote device and one or more servers.

FIG. 2 is a flowchart illustrating a method of performing a mobile savings bond transaction.

FIG. 3 is a diagram illustrating an example front side of a savings bond with a digital stamp added thereto.

FIG. 4 is a diagram illustrating an example back side of a savings bond with transaction information added thereto.

FIG. 5 is a diagram illustrating savings bond image data associated with a digital certificate.

FIG. 6 is a block diagram illustrating an example of a machine upon which one or more embodiments may be implemented.

### DETAILED DESCRIPTION

Systems and methods are disclosed herein for executing remote transactions for debt securities, particularly United States savings bonds. Conventionally, consumers have needed to visit a bank location, or convert a physical bond to electronic forms using an online government service. The system disclosed herein allows a consumer to cash a savings bond using a remote computing device, such as a mobile phone, tablet, laptop computer, desktop computer, or the like. The consumer obtains images of the savings bond, such as with a camera, scanner, or other image capture device. Upon initiation of the transaction, a current value of the savings bond is obtained. The current value may be obtained through a variety of sources such as through a third party valuation application. A digital indicator, such as a digital stamp, is generated that includes data such as the current value, the date, and the financial institution cashing the savings bond. The digital indicator is associated with the image data, such as through adding the digital data as a digital stamp to the image data such that the digital stamp appears on the image of the savings bond when viewed with an image viewing application.

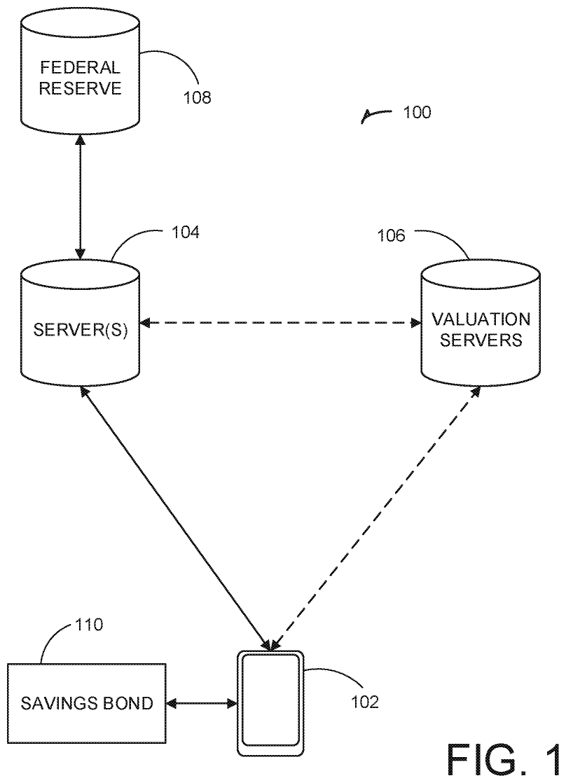

FIG. 1 is a network diagram illustrating a system 100 that includes a remote device 102 and servers 104, 106, and 108. The remote device 102 may be any computing device such as a phone, tablet, laptop computer, desktop computer, or the like. The remote device 102 may be configured to obtain digital images such as through a connected or integrated camera, scanner, or other image capture device. The remote device 102 may be used by a consumer, for example, to perform a remote transaction for a savings bond 110. The remote transaction may include cashing the savings bond 110 and/or depositing finds from cashing of the savings bond 110 into a specified bank account. In one example, the consumer may have an account with a financial institution. The consumer may access the account through one or more applications executing on the remote device 102 and configured to authenticate an identity of the consumer.

The servers 104 may be one or more servers configured to execute one or more applications for a financial institution. For example, the servers may execute mobile banking applications that allow a user of the remote device 102 to access bank account information and actions through the remote device 102. The servers 106 may be one or more servers run by a third party and configured to execute one or more applications capable of providing a present value for a debt security, such as a United States savings bond. In one example, the servers 106 may be servers run by the United States Treasury. The servers 108 may be one or more servers configured to execute one or more applications to receive and store record data regarding cashed savings bonds. In one example, the servers 108 may be servers run by the United States Federal Reserve.

The remote device 102 may be connected to communicate with the servers 104 and the servers 106 over one or more network connections. The network connections may include one or more wired and/or wireless connections that facilitate data communication using one or more communication protocols. For example, the remote device 102 may connect through one or more wireless networks including 3rd generation (3G), 4th generation (4G), long term evolution (LTE), 5th generation (5G) or any other cellular network, wireless networks according to the Institute of Electrical and Electronics Engineers (IEEE) 802.11 family of standards known as Wi-Fi®, IEEE 802.16 family of standards known as WiMax®, IEEE 802.16.4 family or any other wireless network.

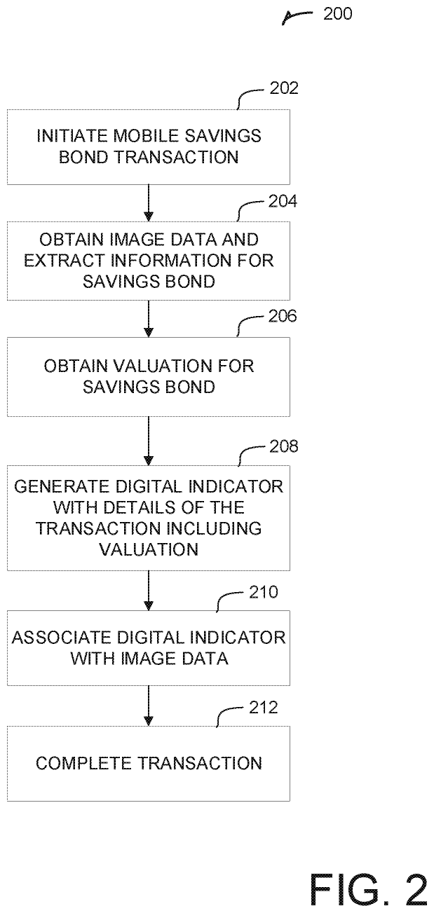

With continued reference to FIG. 1, FIG. 2 is a flowchart illustrating a method 200 of performing a remote savings bond transaction. At step 202, a consumer initiates a transaction for the savings bond 110, which may be United States Series I savings bond, Series E savings bond, Series EE savings bond, or the like. The transaction may be initiated through the remote device 102, which may be a phone, tablet, laptop computer, desktop computer, or the like. At step 204, the consumer may capture image data of the savings bond 102. In an example, the image data may include digital images of the front side and the back side of the savings bond. The digital images may be captured using a camera, scanner, or other image capture device integrated with, or otherwise associated with, the remote device 102. The images may be obtained by a user of the remote device 102 by the user manually obtaining the images, or by one or more applications running on the mobile device 102 and configured to automatically obtain the images through image recognition of the front side and/or the back side of the savings bond 110 within a field of view of the image capture device of the remote device 102.

In one example, information from the savings bond 110 may be automatically extracted from the digital images by one or more applications executing on the remote device 102. The data may be extracted using pattern recognition on the digital images, through input from the consumer, or a combination thereof. In some examples, the one or more applications may employ one or more forms of artificial intelligence/machine learning for extraction of the information from the savings bond 110. The information extracted may include a denomination, a series, an ownership, an issue date, a print date, an address, a serial number, and the like. At step 206, the current value of the savings bond is obtained. This may be through a third party valuation service, for example. In an example, the third party valuation service may provide valuation information to an application running on the remote device 102 through an application programming interface (API). The API may receive data as input, such as the information obtained from the image data captured by the remote device 102 at step 204. The data may be provided to the one or more servers 106 executing one or more valuation applications. In an example, the one or more servers 106 may be United States Treasury servers. The application running on the remote device may receive a current valuation for the savings bond from the third party valuation service.

In another example, rather than obtaining the valuation data directly from the servers 106, the image data and the information regarding the savings bond 110 may be provided to one or more applications running on the servers 104 from the remote device 102. The applications running on the servers 104 may then obtain the valuation data from the servers 106. Applications running on the servers 104 may access the valuation information through the API discussed above, for example, or through any other method.

At step 208, a digital indicator is generated for the transaction. The digital indicator may be a digital image, certificate, or other form of data that indicates details regarding the transaction of the savings bond 110. These details may include a current valuation, a transaction date, a financial institution handling the transaction, an address of the financial institution, and the like. The digital indicator may be generated by the remote device 102 itself, by applications running on servers 104 of the financial institution, by applications running on third party servers, or by any other service.

At step 210, the image data is associated with the digital indicator. In one example, the digital indicator is a digital stamp that is added to a front image of the savings bond. The digital stamp may be added to the image data such that the digital stamp becomes part of the front image and displays when the front image is viewed through a display. For example, the digital stamp may be added to the front image such that the digital stamp displays in a similar location as physical stamps are added when cashing a savings bond in person. This may be between the ownership information and the issue date information on the front side of the savings bond. In another example, a the digital indicator may be a digital certificate generated to include the details of the transaction. The digital certificate can be linked to the image data as opposed to added to the image data such that when the front image of the savings bond 110 is viewed through a display, the certificate is not displayed on the front image. In another example, an application may be configured to receive the image data and overlay the front side image automatically with data obtained from the certificate.

At step 212, the transaction is completed. This may include providing a digital signature on the back image of the savings bond 110, for example. In other examples, a user of the remote device 102 may physically sign the back of the savings bond 110 prior to obtaining the image data. In another example, the digital certificate may act as, or include, a digital signature for the user of the remote device 102.

If the user of the remote device 102 is a customer of the financial institution executing the one or more applications on the servers 104, the user may have the option to deposit the valuation amount of the savings bond 110 into an account owned by the user. In this example, a digital indicator may be generated to indicate details of the deposit. This indicator may include a deposit account, the financial institution, an address of the financial institution, a transaction date, and the like. The digital indicator may be a digital stamp added to the back image of the savings bond 110, may be a digital certificate, or the like. In an example, the digital indicator for the deposit may be included in a same digital certificate as the valuation digital indicator generated at step 208. Following the transaction, the digital image data and/or digital indicators may be transmitted to the servers 108 for record keeping, for example.

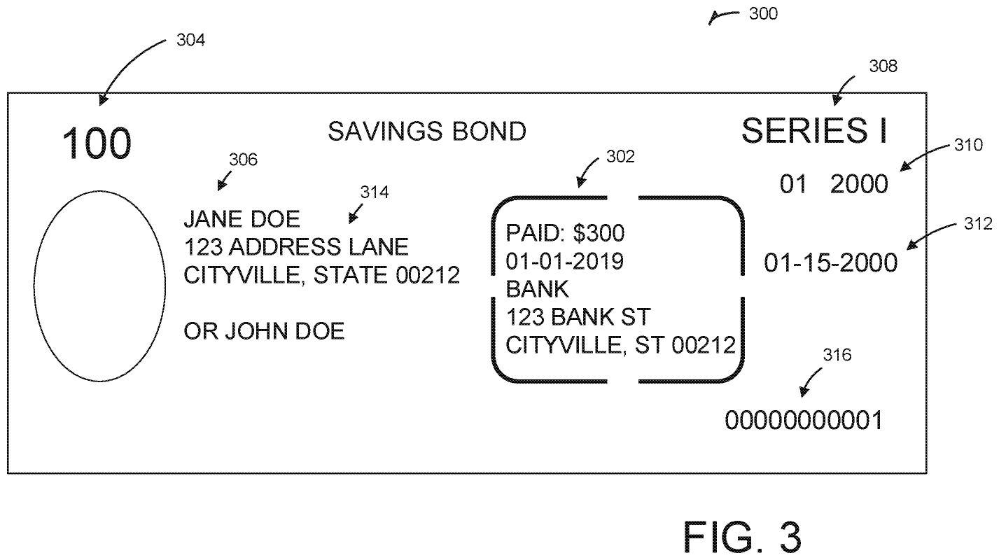

FIG. 3 is a diagram illustrating an example front side image 300 of a savings bond with a digital stamp 302 added thereto. The front side image 300 may be obtained by a camera, scanner, or other image capture device connected to or otherwise associated with a computing device. One or more applications executing on the computing device may be configured to obtain data from the front side image such as the denomination 304, ownership information 306, a series 308, an issue date 310, a print date 312, an address 314, and a serial number 316.

The digital stamp 302 may include transactional information such as a current value, a transaction date, a financial institution, an address of the financial institution cashing the savings bond, and the like. When cashing a physical savings bond in person, a physical stamp is applied to the front of the savings bond between the ownership information 306 and the print date 312. The digital stamp 302 may be added to the front image 300 in this same location by one or more applications executing on the computing device, or in any other desirable location on the front image 300.

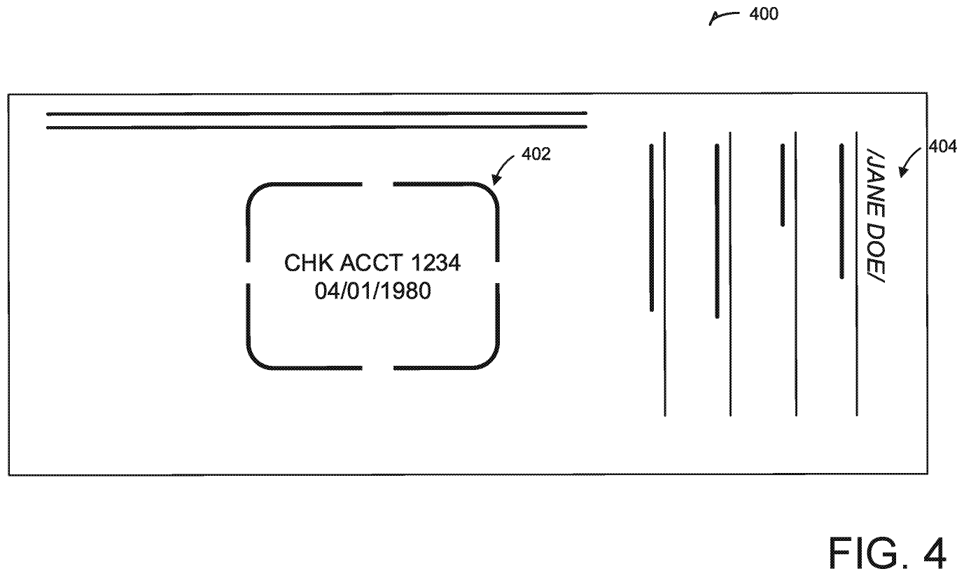

FIG. 4 is a diagram illustrating an example back side image 400 of a savings bond with transaction information 402 and a signature 404 added thereto. The back side image 400 may be obtained by a camera, scanner, or other image capture device connected to or otherwise associated with a computing device. One or more applications executing on the computing device may be configured to obtain data from the back side image, for example.

The transaction information 402 may include transactional information such as an account identifier, a date associated with the account, and the like. For example, the account identifier may be checking or savings account number. The date associated with the account may be a date on which the account was opened, for example. When cashing a physical savings bond in person, a physical stamp may be applied to the back of the savings bond. The transaction information 402 may be added to the back image 400 at any desired location on the back image 400.

The signature 404 may also be added by one or more applications executing on the computing device, for example. The signature 404 may be a digital signature, image of a user's signature, or any other form of signature. In some examples, a user may sign the back of the savings bond prior to obtaining the back side image 400.

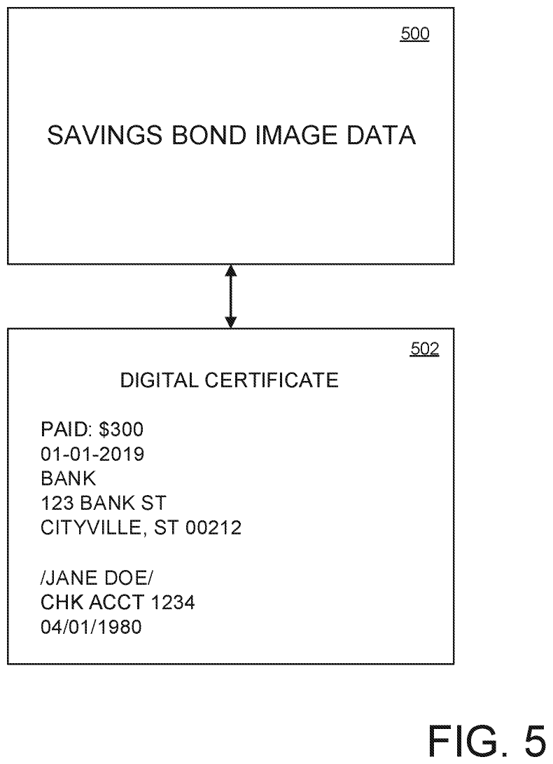

FIG. 5 is a diagram illustrating savings bond image data 500 associated with a digital certificate 502. The examples illustrated in FIGS. 3 and 4 describe adding images 302 and 402 to the front side image 300 and the back side image 302, respectively. In the example illustrated in FIG. 5, the digital stamp information and/or transaction information can be included in the digital certificate 502 rather than added directly to the image data 500. The image data 500 may include the front side image 300 without the digital stamp 302 and/or the back side image 400 without the transaction information 402.

The digital certificate 502 may be stored in any digital format and include any desired information. For example, the digital certificate may include a current value, a transaction date, a financial institution and address of the financial institution cashing the savings bond, an account associated with the transaction, a date associated with the account, a signature, and the like. The digital certificate 502 may include an identifier to link the digital certificate 502 to the image data 500.

By utilizing digital indicators, such as a digital stamp or a digital certificate, users are able to remotely cash savings bonds using a computing device and image capture device. The use of the digital indicators removes the need for a physical stamp or other physical indicator that is used during current processes for cashing savings bonds, which improves the overall user experience when performing savings bond transactions.

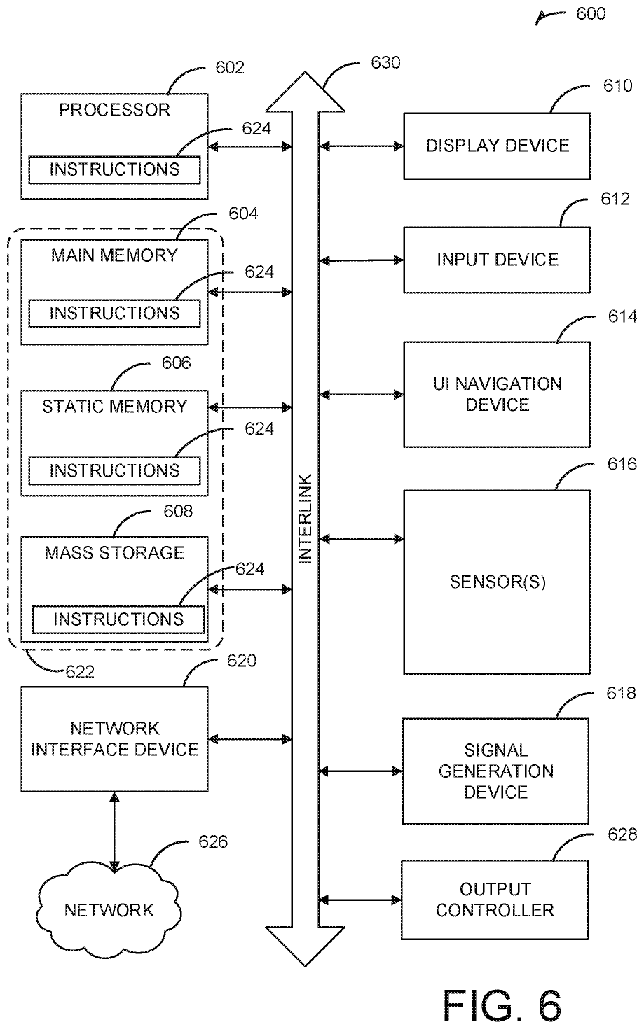

FIG. 6 illustrates a block diagram of an example machine 600 upon which any one or more of the techniques (e.g., methodologies) discussed herein may perform. For example, the machine 600 can be any one or more of the remote device 102 and the servers 104, 106, and 108. The Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drive, tape drive, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.16.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of executing a remote transaction for a debt security, the method comprising:
using one or more hardware processors:
receiving a transaction request for the debt security;
receiving image data from a remote device, the image data comprising one or more digital images of the debt security, wherein the image data comprises a front image of a front side of the debt security and a back image of a back side of the debt security opposite the front side;
extracting identifiers of the debt security from the image data;
transmitting the extracted identifiers to a valuation entity;
receiving valuation information for the debt security from the valuation entity, the valuation information specifying a current monetary value of the debt security;
generating a first digital indicator that comprises the valuation information received from the valuation entity;
in response to generating the digital indicator
adding the first digital indicator to the image data as a digital stamp to the front image of the front side of the debt security;
determining that a user of the remote device is a customer of a specified financial institution;
generating a second digital indicator that includes account data associated with the user;
adding the second digital indicator to the back image on the back side of the debt security; and
completing a transaction for the debt security.

2. The method of claim 1, the method further comprising:
generating the first digital indicator by the remote device; and
receiving the first digital indicator from the remote device.

3. The method of claim 1, wherein receiving the image data from the remote device comprises receiving, by one or more servers, the image data from the remote device and wherein the method further comprises generating the first digital indicator by the one or more servers.

4. The method of claim 1, wherein the first digital indicator comprises data indicating a full current redemption value (CRV), a financial institution executing the transaction, and a date of the transaction.

5. (canceled)

6. (canceled)

7. The method of claim 1, further comprising verifying the current monetary value is less than a specified amount if the user is not a customer of the specified financial institution.

8. The method of claim 1, wherein the debt security is a United States savings bond.

9. A system for executing a remote transaction for a debt security, the system comprising:
one or more hardware processors;
one or more memories, storing instructions; which when executed, cause the one or more hardware processors to perform operations comprising:
receiving a transaction request for the debt security;
receiving image data from a remote device, the image data comprising one or more digital images of the debt security, wherein the image data comprises a front image of a front side of the debt security and a back image of a back side of the debt security opposite the front side;
extracting identifiers of the debt security from the image data;
transmitting the extracted identifiers to a valuation entity;
receiving valuation information for the debt security from the valuation entity, the valuation information specifying a current monetary value of the debt security;
generating a first digital indicator that comprises the valuation information received from the valuation entity;
in response to generating the digital indicator
adding the first digital indicator to the image data as a digital stamp to the front image of the front side of the debt security;
determining that a user of the remote device is a customer of a specified financial institution;
generating a second digital indicator that includes account data associated with the user;
adding the second digital indicator to the back image on the back side of the debt security; and
completing a transaction for the debt security.

10. The system of claim 9, wherein the operations further comprise:
generating the first digital indicator by the remote device; and
receiving the first digital indicator from the remote device.

11. The system of claim 9, wherein the operations of receiving the image data from the remote device comprise receiving, by one or more servers, the image data from the remote device and the operations further comprise generating the first digital indicator by the one or more servers.

12. The system of claim 9, wherein the first digital indicator comprises data indicating a full current redemption value (CRV), a financial institution executing the transaction, and a date of the transaction.

13. (canceled)

14. (canceled)

15. The system of claim 9, wherein the operations further comprise verifying the current monetary value is less than a specified amount if the user is not a customer of the specified financial institution.

16. The system of claim 9, wherein the debt security is a United States savings bond.

17. A system comprising:
means for receiving a transaction request for a debt security;
means for receiving image data from a remote device, the image data comprising one or more digital images of the debt security, wherein the image data comprises a front image of a front side of the debt security and a back image of a back side of the debt security opposite the front side;
means for extracting identifiers of the debt security from the image data;
means for transmitting the extracted identifiers to a valuation entity;
means for receiving valuation information for the debt security from the valuation entity, the valuation information specifying a current monetary value of the debt security;
means for generating a first digital indicator that comprises the valuation information received from the valuation entity;
means for adding the first digital indicator to the image data as a digital stamp to the front image of the front side of the debt security in response to generating the digital indicator;
means for determining that a user of the remote device is a customer of a specified financial institution;
means for generating a second digital indicator that includes account data associated with the user;
means for adding the second digital indicator to the back image on the back side of the debt security; and
means for completing a transaction for the debt security.

18. The system of claim 17, wherein the means for adding the first digital indicator to the front image of the front side of the debt security comprise:
means for generating the first digital indicator by the remote device; and
means for receiving the first digital indicator from the remote device.

19. The system of claim 17, wherein the means for receiving the image data from the remote device comprise means for receiving, by one or more servers, the image data from the remote device and wherein the means for adding the first digital indicator to the front image of the front side of the debt security comprise means for generating the first digital indicator by the one or more servers.

20. (canceled)
